(19) United States
(12) Patent Application Publication
(10) Pub. No.: US 2004/0227317 A1
(43) Pub. Date: Nov. 18, 2004

(54) Eccentric scooter having cushioning device

(76) Inventor: Kao Tsun Cheng, Chang Hua (TW)

Correspondence Address: Kao Tsun Cheng, P.O. Box 63-298, Taichung, 406, TW

(21) Appl. No.: 10/439,688

(22) Filed: May 14, 2003

(51) Int. Cl. B62M 1/00

(52) U.S. Cl. 280/87.041

(57) ABSTRACT

An eccentric cycle includes two arms having upper portions attached to a stem, a wheel having an eccentric rear wheel axle, two levers having one end pivotally secured to lower portions of the arms and each having other end attached to the wheel axle, and two cushioning members coupled between the arms and the levers to cushion a relative movement between the levers and the arms, in order to cushion the stem relative to the wheel. Each cushioning member includes a conduit pivotally coupled to the levers, a pole slidably received in the conduit and pivotally secured to the arms, and a spring member to cushion the pole relative to the conduit.

### BACKGROUND OF THE INVENTION

1. Field of the Invention

The present invention relates to a scooter or cycle or unicycle, and more particularly to an eccentric scooter or cycle or unicycle having a cushioning device for cushioning either the wheel axles of the scooter or cycle.

2. Description of the Prior Art

Typical scooters or cycles comprise a front wheel rotatably attached to the front portion of a frame with a front axle, and a rear wheel rotatably attached to the rear portion of the frame with a rear axle. The typical unicycles also comprise a single wheel rotatably attached to the bottom of a frame with a wheel axle.

The wheel axles are normally disposed in the geometric center of the wheels, such that the typical scooters or cycles or the typical unicycles may be smoothly moved on the roads.

In order to increase the recreational effect, some of the typical scooters or cycles or the typical unicycles may comprise a wheel axle disposed offset from or disengaged from the geometric center of the wheels, for allowing the typical scooters or cycles or unicycles to be moved in a horse-riding type movement or exercise.

For example, U.S. Pat. No. 5,249,847 to Lee discloses one of the typical eccentric cycles and comprises a front wheel axle adjustably attached to the front wheel, for allowing the front wheel axle to be adjusted or disengaged from the geometric center of the front wheel, and thus for allowing the typical cycle to be moved in a horse-riding type movement or exercise selectively.

However, the front fork of the eccentric cycle is directly and rotatably attached to the front wheel axle. No cushioning devices have been provided between the front fork and the front wheel axle, because of the eccentric arrangement of the wheel axle to the wheel, such that the eccentric cycle may not be suitably cushioned with various cushioning devices.

The present invention has arisen to mitigate and/or obviate the afore-described disadvantages of the conventional eccentric scooters or cycles or unicycles.

### SUMMARY OF THE INVENTION

The primary objective of the present invention is to provide an eccentric scooter or cycle or unicycle including a cushioning device for cushioning either the front or the rear wheel axle of the scooter or cycle or unicycle.

In accordance with one aspect of the invention, there is provided an eccentric cycle comprising a stem, two arms including upper portions attached to the stem, and each including a lower portion, a wheel including an eccentric rear wheel axle, two levers each including a first end pivotally secured to the lower portions of the arms respectively, and each including a second end attached to the wheel axle, and two cushioning members coupled between the arms and the levers to cushion a relative movement between the levers and the arms.

Each of the cushioning members includes a conduit having a lower portion pivotally coupled to the levers, and a pole slidably received in the conduit and having an upper end pivotally secured to the upper portions of the arms respectively, to support the relative movement between the levers and the arms.

Each of the levers includes a bracket disposed on the upper portion thereof, the lower portions of the conduits are pivotally secured to the brackets of the levers with pivot rods respectively. Each of the arms includes a bracket disposed on the upper portion thereof, the upper ends of the poles are pivotally secured to the brackets of the arms with pivot pins respectively.

Each of the cushioning members includes a spring disposed in the conduit and engaged with the pole, to cushion the pole relative to the conduit. Each of the arms includes a bracket disposed on the lower portion thereof, the first ends of the levers are pivotally secured to the brackets of the arms with pivot shafts respectively.

A frame may further be provided and may include a front portion rotatably attached to the stem and may include a rear portion, a rear wheel rotatably attached to the rear portion of the frame with an eccentric rear wheel axle, and a cushioning device coupled between the frame and the rear wheel to cushion a relative movement between the frame and the rear wheel.

The cushioning device includes two second arms having front portions attached to the rear portion of the frame and each having a rear portion, two second levers each having a first end pivotally secured to the rear portions of the arms respectively and each having a second end attached to the rear wheel axle, and two second cushioning members coupled between the second arms and the second levers to cushion a relative movement between the second levers and the second arms.

Each of the second cushioning members includes a conduit having an end portion pivotally coupled to the second arms, and a pole slidably received in the conduit and having an end pivotally secured to the second ends of the second levers, to support the relative movement between the second levers and the second arms.

Each of the second levers includes a bracket disposed on the second end thereof, the ends of the poles are pivotally secured to the brackets of the second levers respectively. Each of the second arms includes a bracket disposed on the front portion thereof, the end portions of the conduits are pivotally secured to the brackets of the second arms respectively. Each of the second cushioning members may further include a spring member disposed in the conduit and engaged with the pole, to cushion the pole relative to the conduit.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan view of an eccentric scooter or unicycle or cycle in accordance with the present invention;

FIG. 2 is a partial perspective view of the eccentric cycle;

FIG. 3 is a partial exploded view of the eccentric cycle;

FIGS. 4, 5 are partial plan views illustrating the operation of the eccentric cycle;

FIG. 6 is a perspective view illustrating the other arrangement of the eccentric cycle;

FIG. 7 is a plan schematic view illustrating the operation of the eccentric cycle as shown in FIG. 6; and

FIG. 8 is a plan schematic view illustrating the further arrangement of the eccentric cycle.

### DETAILED DESCRIPTION OF THE PREFERRED EMBODIMENT

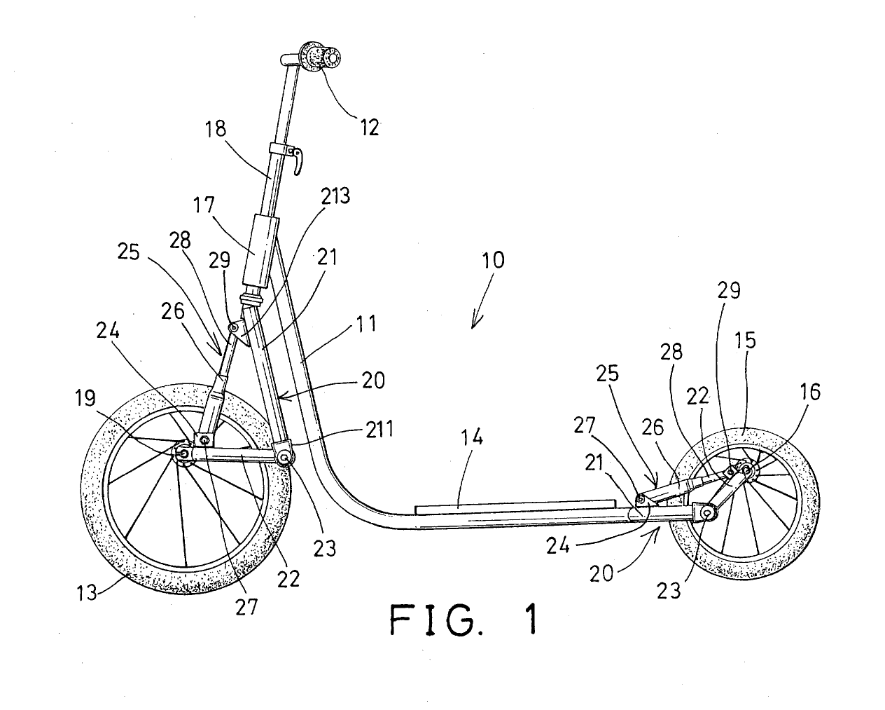

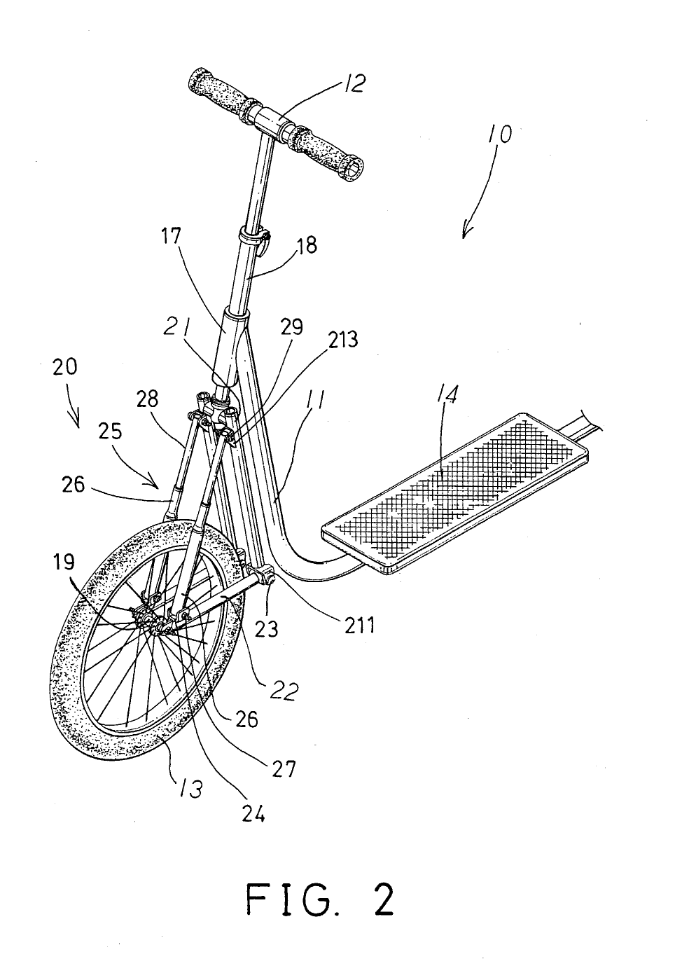

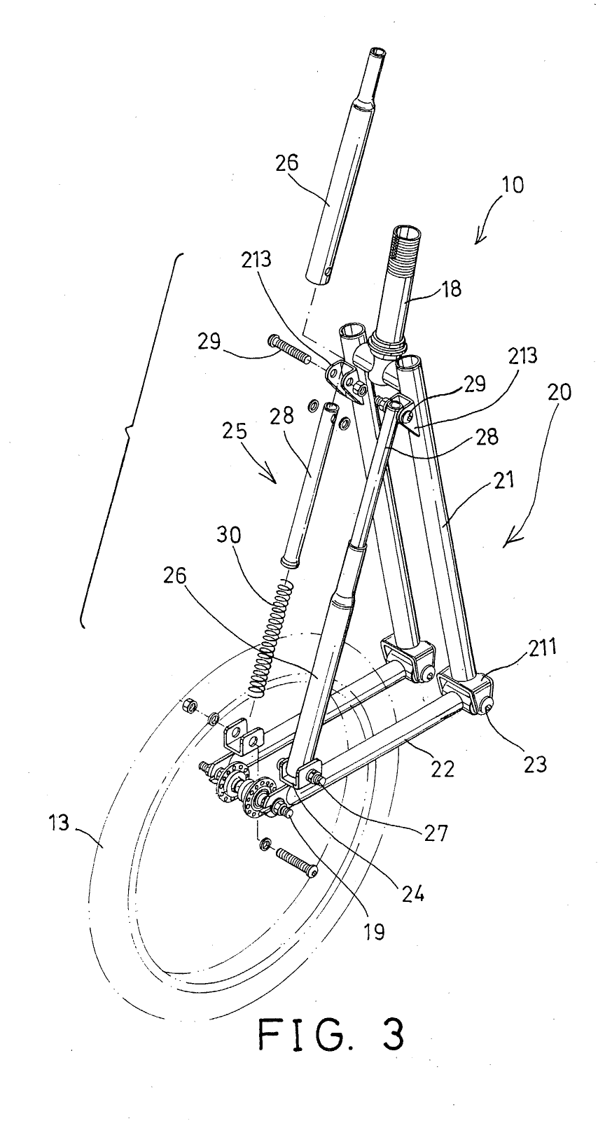

Referring to the drawings, and initially to FIGS. 1-4, an eccentric scooter or cycle 10 in accordance with the present invention comprises a cycle frame 11, a handle 12 rotatably attached to a front tube 17 of the frame 11 with a stem 18, and a foot support or pedal 14 selectively disposed on the frame 11 for supporting the users.

A front wheel 13 may be rotatably attached to the bottom of the stem 18 with a front wheel axle 19 which is preferably arranged eccentric relative to the front wheel 13, and a rear wheel 15 may be rotatably attached to the rear portion of the frame 11 with a rear wheel axle 16 which is preferably arranged eccentric relative to the rear wheel 15, for allowing the cycle 10 to be moved on the road or the like.

The cycle 10 in accordance with the present invention may also comprise a seat or seat cushion (not shown) attached on top of the stem 18, and a single wheel 13 to be rotatably attached to the bottom of the stem 18 with the wheel axle 19, in order to form a unicycle. The above-described are the basic structures of the conventional scooters or unicycles or cycles, and will not be described in further details.

The eccentric scooter or cycle 10 in accordance with the present invention further comprises a cushioning device 20 to be attached between the stem 18 and the wheel axle 19 of the wheel 13, and/or to be attached between the frame 11 and the rear wheel axle 16 of the wheel 15, for cushioning the scooter or unicycle or cycle.

As shown in FIGS. 1-7, the cushioning device 20 includes two arms 21 having upper ends secured to the stem 18 or extended downwardly from the stem 18 and inclined relative to the stem 18, such that the arms 21 and the stem 18 may be formed as a fork device for the cycle.

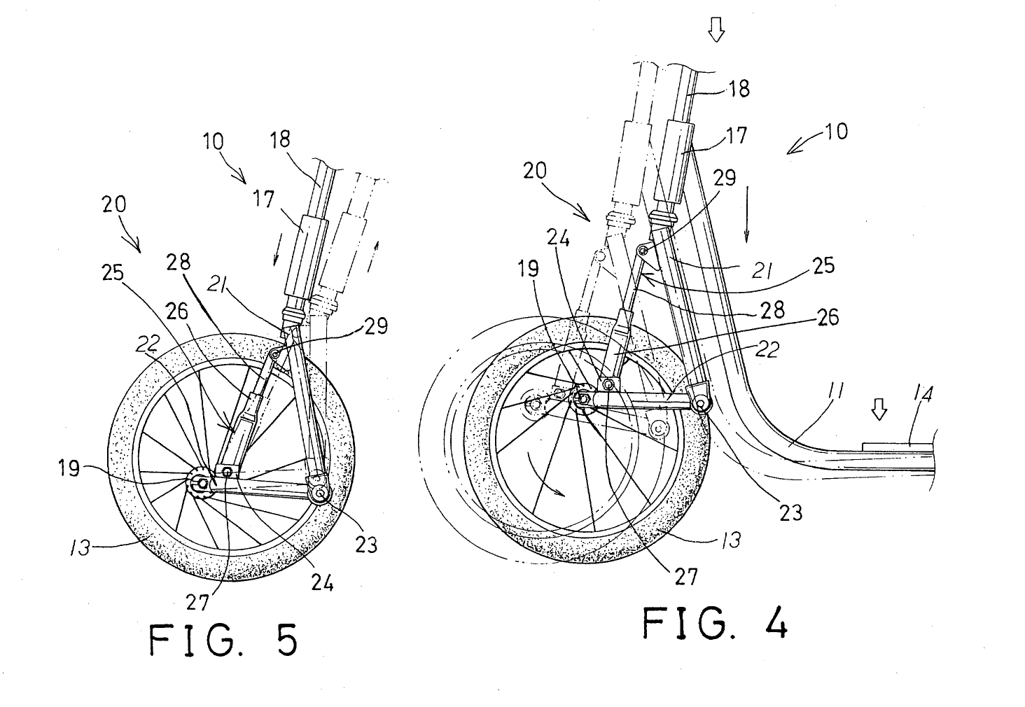

Two levers 22 include rear ends rotatably or pivotally secured to the bottom of the arms 21, such as rotatably or pivotally secured to the bottom bracket 211 of the arms 21 with pivot shafts 23, and include front ends attached or secured to the wheel axle 19 of the wheel 13, for allowing the levers 22 and the wheel 13 to be slightly rotated relative to the arms 21 (FIGS. 4, 5). Each of the levers 22 preferably includes a bracket 24 disposed on the front portion thereof.

The cushioning device 20 further includes two cushioning members 25 resiliently coupled between the front portion of the levers 22 and the upper portion of the arms 21 respectively, in order to provide a resilient or cushioning force between the arms 21 or the stem 18 and the levers 22 or the wheel 13, and so as to support and/or to cushion the movements of the arms 21 and the frame 11 relative to the wheel 13.

For example, each of the cushioning members 25 includes a conduit 26 having a lower end rotatably or pivotally secured to the wheel axle 19 or to the front portion of the levers 22, such as rotatably or pivotally secured to the bracket 24 of the respective lever 21 with a pivot rod 27.

Each of the cushioning members 25 further includes a pole 28 slidably received in the respective conduit 26 and having an upper end rotatably or pivotally secured to the upper portion of the arms 21, such as rotatably or pivotally secured to the upper bracket 213 of the arm 21 with a pivot pin 29, for allowing the levers 22 and the wheel 13 to be slightly rotated relative to the arms 21.

Each of the cushioning members 25 further includes a resilient or spring member 30 disposed in each of the conduits 26 and engaged with the respective pole 28, in order to cushion the pole 28 and the arms 21, and thus to cushion the relative movement between the levers 22 and the arms 21, or between the wheel 13 and the stem 18.

Alternatively, the cushioning members 25 may also be the typical actuators, such as the pneumatic or hydraulic cylinders, or the like, and may thus also be used to provide a resilient or cushioning force between the arms 21 or the stem 18 and the levers 22 or the wheel 13, and so as to cushion the arms 21 and the frame 11 relative to the wheel 13.

It is to be noted that the wheel axle 19 is disposed eccentric relative to the wheel 13, such that the wheel axle 19 and the stem 18 or the frame 11 of the cycle 10 may be moved up and down relative to the wheel 13 (FIGS. 4, 5, 7). The cushioning device 20 may provide a resilient or cushioning force, particularly to cushion the downward movement of the arms 21 or the stem 18 or the handle 12 relative to the wheel 13, and thus for allowing the users to comfortably ride the eccentric cycle.

Referring again to FIG. 1, similarly, the cushioning device 20 may also be provided and disposed between the frame 11 and the rear wheel 15, in order to provide a resilient or cushioning force between the frame 11 and the rear wheel 15, and thus to cushion the frame 11 and the users.

For example, the arms 21 may be secured to the rear portion of the frame 11, the levers 22 may also pivotally secured to the rear ends of the arms 21 with the pivot shafts 23 and may also attached to the rear wheel axle 16, and the cushioning members 25 may also be coupled between the rear portions of the levers 22 and the front portions of the arms 21, to cushion the relative movement between the levers 22 and the arms 21, or between the wheel 15 and the frame 11.

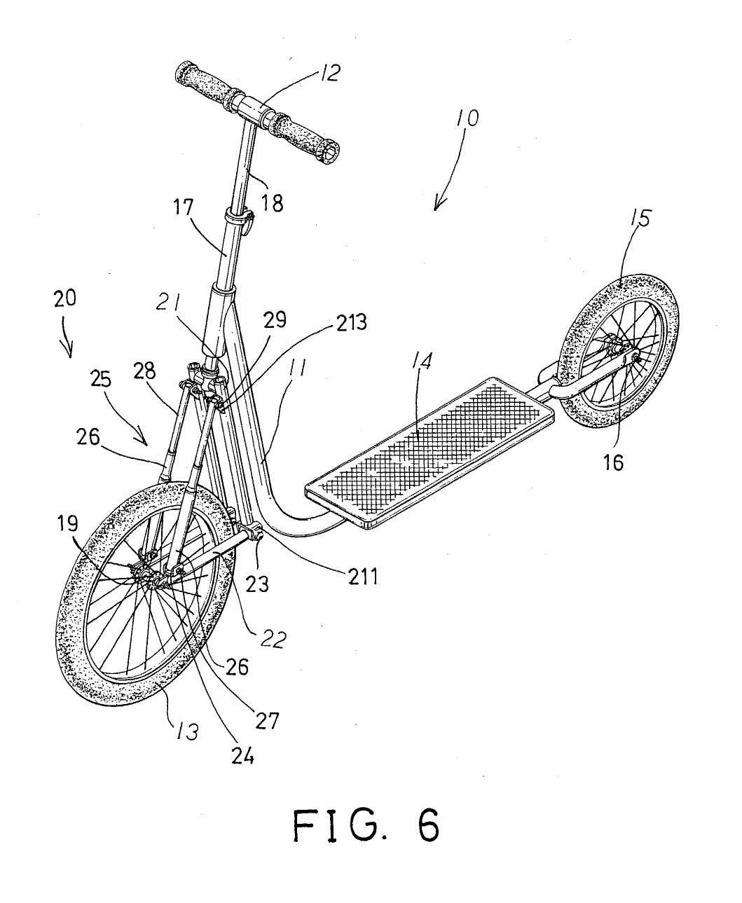

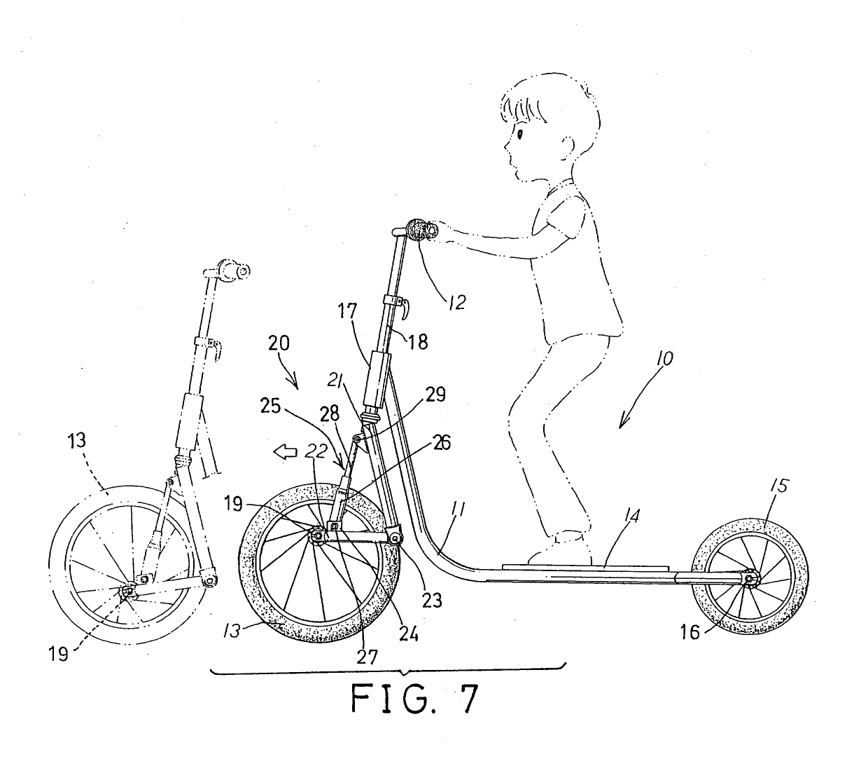

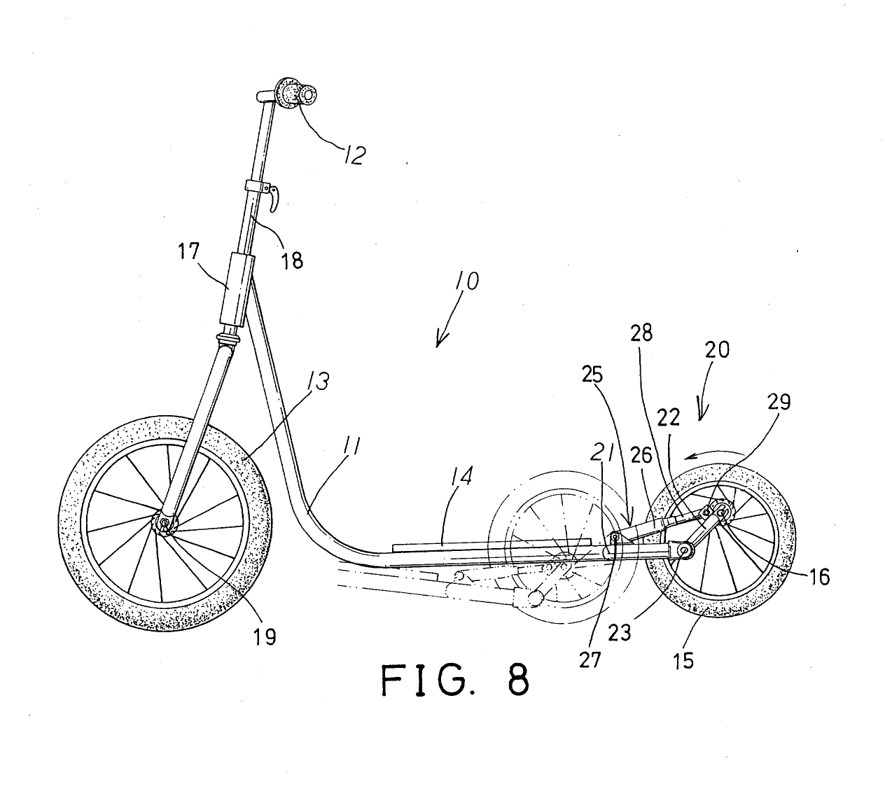

Alternatively, as shown in FIGS. 6 and 7, the eccentric cycle in accordance with the present invention may include only a cushioning device 20 attached to the front portion of the cycle or disposed between the stem 18 and the front wheel 13; or may include only a cushioning device 20 attached to the rear portion of the cycle or disposed between the frame 11 and the rear wheel 15, as shown in FIG. 8.

Accordingly, the eccentric cycle in accordance with the present invention includes a cushioning device for cushioning either the front or the rear wheel axle of the scooter or cycle or unicycle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An eccentric cycle comprising:
a stem,
two arms including upper portions attached to said stem, and each including a lower portion,
a wheel including an eccentric rear wheel axle,
two levers each including a first end pivotally secured to said lower portions of said arms respectively, and each including a second end attached to said wheel axle, and
two cushioning members coupled between said arms and said levers to cushion a relative movement between said levers and said arms.

2. The eccentric cycle as claimed in claim 1, wherein each of said cushioning members includes a conduit having a lower portion pivotally coupled to said levers, and a pole slidably received in said conduit and having an upper end pivotally secured to said upper portions of said arms respectively, to support the relative movement between said levers and said arms.

3. The eccentric cycle as claimed in claim 2, wherein each of said levers includes a bracket disposed on said upper portion thereof, said lower portions of said conduits are pivotally secured to said brackets of said levers with pivot rods respectively.

4. The eccentric cycle as claimed in claim 2, wherein each of said arms includes a bracket disposed on said upper portion thereof, said upper ends of said poles are pivotally secured to said brackets of said arms with pivot pins respectively.

5. The eccentric cycle as claimed in claim 2, wherein each of said cushioning members further includes a spring member disposed in said conduit and engaged with said pole, to cushion said pole relative to said conduit.

6. The eccentric cycle as claimed in claim 1, wherein each of said arms includes a bracket disposed on said lower portion thereof, said first ends of said levers are pivotally secured to said brackets of said arms with pivot shafts respectively.

7. The eccentric cycle as claimed in claim 1 further comprising a frame having a front portion rotatably attached to said stem and having a rear portion, a rear wheel rotatably attached to said rear portion of said frame with an eccentric rear wheel axle, and a cushioning device coupled between said frame and said rear wheel to cushion a relative movement between said frame and said rear wheel.

8. The eccentric cycle as claimed in claim 7, wherein said cushioning device includes two second arms having front portions attached to said rear portion of said frame and each having a rear portion, two second levers each having a first end pivotally secured to said rear portions of said arms respectively and each having a second end attached to said rear wheel axle, and two second cushioning members coupled between said second arms and said second levers to cushion a relative movement between said second levers and said second arms.

9. The eccentric cycle as claimed in claim 8, wherein each of said second cushioning members includes a conduit having an end portion pivotally coupled to said second arms, and a pole slidably received in said conduit and having an end pivotally secured to said second ends of said second levers respectively, to support the relative movement between said second levers and said second arms.

10. The eccentric cycle as claimed in claim 8, wherein each of said second levers includes a bracket disposed on said second end thereof, said ends of said poles are pivotally secured to said brackets of said second levers respectively.

11. The eccentric cycle as claimed in claim 8, wherein each of said second arms includes a bracket disposed on said front portion thereof, said end portions of said conduits are pivotally secured to said brackets of said second arms respectively.

12. The eccentric cycle as claimed in claim 8, wherein each of said second cushioning members further includes a spring member disposed in said conduit and engaged with said pole, to cushion said pole relative to said conduit.
